(19) United States
(12) Patent Application Publication
(10) Pub. No.: US 2021/0200812 A1
(43) Pub. Date: Jul. 1, 2021

(54) INFORMATION PROCESSING APPARATUS AND NON-TRANSITORY COMPUTER READABLE MEDIUM STORING COMPUTER PROGRAM

(71) Applicant: FUJI XEROX CO., LTD., Tokyo (JP)

(72) Inventor: Yuji SAKAMOTO, Kanagawa (JP)

(73) Assignee: FUJI XEROX CO., LTD., Tokyo (JP)

(21) Appl. No.: 16/885,287

(22) Filed: May 28, 2020

(30) Foreign Application Priority Data
Dec. 27, 2019 (JP) 2019-237800

(51) Int. Cl. G06F 16/9032; G06F 16/9038; G06F 16/2457; G06F 17/18

(52) U.S. Cl. CPC G06F 16/90332; G06F 16/90328; G06F 17/18; G06F 16/24578; G06F 16/9038

(57) ABSTRACT

An information processing apparatus includes a processor configured to extract a phrase to be used for a search of information from a natural sentence input by a user, search for the information using the extracted phrase, dynamically select a search phrase from the phrase based on the number of appearances of the phrase in the information in a presented range of a result of the search in accordance with an operation related to browsing of the result of the search performed by the user, and execute a process of presenting the selected search phrase.

### CROSS-REFERENCE TO RELATED APPLICATIONS

This application is based on and claims priority under 35 USC 119 from Japanese Patent Application No. 2019-237800 filed on Dec. 27, 2019.

### BACKGROUND

### (i) Technical Field

The present invention relates to an information processing apparatus and a non-transitory computer readable medium storing a computer program.

### (ii) Related Art

For example, JP2002-304418A discloses a search apparatus including a query sentence input section that inputs a query sentence for a search, a search execution section that searches a database storing data of a search target and extracts data similar to the query sentence input by the query sentence input section, a word contribution degree calculation section that calculates a degree of contribution related to a word contributing to extraction performed by the search execution section with respect to a result of the search extracted by the search execution section, and a word contribution degree output section that outputs a contribution degree calculated by the word contribution degree calculation section together with the corresponding word.

### SUMMARY

In a case where a user performs a search using a natural sentence, information including a phrase that is considered meaningful by the user is not necessarily shown at the top of the result of the search. In order to narrow down the result of the search, an effort is required to delete a phrase other than the phrase considered meaningful from multiple phrases.

Aspects of non-limiting embodiments of the present disclosure relate to an information processing apparatus and a non-transitory computer readable medium storing a computer program that can improve an efficiency of a re-search performed by a user by dynamically extracting a phrase considered meaningful by the user compared to a case where such a phrase is not extracted.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to extract a phrase to be used for a search of information from a natural sentence input by a user, search for the information using the extracted phrase, dynamically select a search phrase from the phrase based on the number of appearances of the phrase in the information in a presented range of a result of the search in accordance with an operation related to browsing of the result of the search performed by the user, and execute a process of presenting the selected search phrase.

### BRIEF DESCRIPTION OF THE DRAWINGS

Exemplary embodiment(s) of the present invention will be described in detail based on the following figures, wherein:

FIG. 1 is a diagram illustrating a schematic configuration of an information search system according to this exemplary embodiment;

FIG. 2 is a block diagram illustrating a hardware configuration of a search server;

FIG. 3 is a block diagram illustrating an example of a functional configuration of the search server;

FIG. 4 is a flowchart illustrating a flow of information search process performed by the search server;

FIG. 5 is a diagram illustrating an example of a measurement result of the number of appearances of each extracted phrase in a result of a search and the number of contents selected by a user;

FIG. 6 is a diagram illustrating an example of a relationship between phrases and an IDF value;

FIG. 7 is a diagram illustrating an example of a relationship between an extracted search phrase and the number of appearances of each search phrase in a natural sentence;

FIG. 8 is a diagram illustrating an example of the number of presentation of the result of the search;

FIG. 9 is a diagram illustrating an example of the measurement result of the number of appearances of each extracted phrase in the result of the search and the number of contents selected by the user;

FIG. 10 is a diagram illustrating an example of the number of displayed entries on a user terminal and contents opened by the user for each search process; and

FIG. 11 is a diagram illustrating an example of presentation of the search phrase on the user terminal.

### DETAILED DESCRIPTION

Hereinafter, one example of an exemplary embodiment of the present disclosure will be described with reference to the drawings. In each drawing, identical or equivalent constituents and parts are designated by identical reference signs. In addition, dimensional ratios in the drawings are exaggerated for convenience of description and may be different from actual ratios.

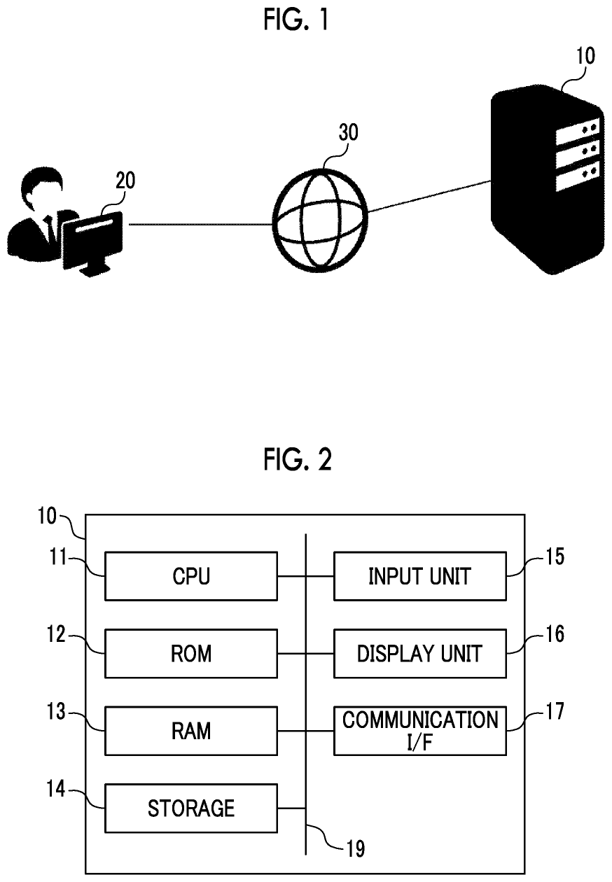

FIG. 1 is a diagram illustrating a schematic configuration of an information search system according to this exemplary embodiment. The information search system illustrated in FIG. 1 is configured to include a search server 10 as an information processing apparatus and a user terminal 20. The search server 10 and the user terminal 20 are connected to each other through a communication line 30 such as the Internet or an intranet. The communication line 30 may be a wired line or a wireless line, and may be a dedicated line used by only a specific user or a public line in which the same line is shared by an unspecified number of users.

The search server 10 is an apparatus that searches for information and returns a result of the search to the user terminal 20 in response to a request for searching for the information from the user terminal 20. A target of the information searched for by the search server 10 includes various electronic data such as image data, text data, document data, voice data, and motion picture data. The data as a target of the search performed by the search server 10 may be stored inside the search server 10 or may be stored in an apparatus outside the search server 10. In the following description, the target of the information searched for by the search server 10 will be referred to as a “content”. For example, the content is information that may be browsed on the Internet or the intranet.

The user terminal 20 is a terminal used by a user of the information search system and may be any terminal such as a desktop computer, a laptop personal computer, a tablet, or a smartphone. The user terminal 20 is an apparatus configured to be capable of communicating with the search server 10 through the communication line 30. The user terminal 20 includes an input apparatus such as a mouse, a keyboard, and a microphone and an output apparatus such as a display and a speaker. The user terminal 20 causes the search server 10 to search for the content under a search condition input by the user using the input apparatus. The user terminal 20 outputs the result of the search of the search server 10 using the output apparatus.

In this exemplary embodiment, the search server 10 is configured to execute not only the search of the content based on a phrase input in the user terminal 20 by the user but also the search of the content based on a natural sentence input in the user terminal 20 by the user. The natural sentence may be input as a text by the user using the keyboard or may be input as a voice by the user toward the microphone.

For example, a sentence “please tell me the term of a patent in Japan” is input in the user terminal 20 as a text or a voice by the user. The search server 10 extracts phrases to be used for the search from the input sentence and executes the search of the content using the extracted phrases. In this example, the search server 10 extracts phrases “Japan”, “patent”, and “term” by decomposing the natural sentence into parts of speech and executes the search of the content using these phrases. The search server 10 finds a content including the phrases “Japan”, “patent”, and “term” and transmits the result of the search to the user terminal 20. The user terminal 20 acquires the result of the search of the search server 10 and outputs the result of the search using the output apparatus.

The result of the search of the content performed by the search server 10 may not be intended by the user. For example, as the length of the natural sentence input by the user is increased, the number of phrases extracted from the natural sentence may be increased. In a case where the number of phrases to be used for the search is increased, information that includes a phrase considered meaningful by the user does not necessarily appear at the top of the result of the search of the search server 10 in a case where the user searches for the content using the natural sentence. In order to narrow down the result of the search, an effort is required for the user to delete a phrase other than the phrase considered meaningful from multiple phrases extracted from the natural sentence.

Therefore, in a case where the user searches for the content using the natural sentence, the search server 10 according to this exemplary embodiment automatically extracts the phrase considered meaningful by the user in accordance with a user operation performed on the result of the search. The search server 10 according to this exemplary embodiment reduces an effort of a re-search performed by the user by automatically extracting the phrase considered meaningful by the user in accordance with the user operation performed on the result of the search.

The information search system illustrated in FIG. 1 includes only one user terminal 20 but may include a plurality of user terminals 20. In addition, the information search system may include a plurality of search servers 10.

FIG. 2 is a block diagram illustrating a hardware configuration of the search server 10.

As illustrated in FIG. 2, the search server 10 includes a central processing unit (CPU) 11, a read only memory (ROM) 12, a random access memory (RAM) 13, a storage 14, an input unit 15, a display unit 16, and a communication interface (I/F) 17. These configurations are connected to be capable of communicating with each other through a bus 19.

The CPU 11 is a central processing unit and executes various programs or controls each unit. That is, the CPU 11 reads a program from the ROM 12 or the storage 14 and executes the program using the RAM 13 as a work region. The CPU 11 controls each configuration and performs various calculation processes in accordance with the program recorded in the ROM 12 or the storage 14. In this exemplary embodiment, the ROM 12 or the storage 14 stores a search program for searching for the content.

The ROM 12 stores various programs and various data. The RAM 13 temporarily stores a program or data as the work region. The storage 14 is configured with a storage apparatus such as a hard disk drive (HDD), a solid state drive (SSD), or a flash memory and stores various programs including an operating system and various data.

The input unit 15 includes a pointing device such as the mouse and the keyboard, and is used for providing various inputs.

The display unit 16 is, for example, a liquid crystal display and displays various information. The display unit 16 may function as the input unit 15 by employing a touch panel type.

The communication interface 17 is an interface for communicating with another apparatus such as the user terminal 20 and uses standards such as Ethernet (registered trademark), FDDI, and Wi-Fi (registered trademark).

In the case of executing the search program, the search server 10 implements various functions using hardware resources described above.

Next, a functional configuration of the search server 10 will be described.

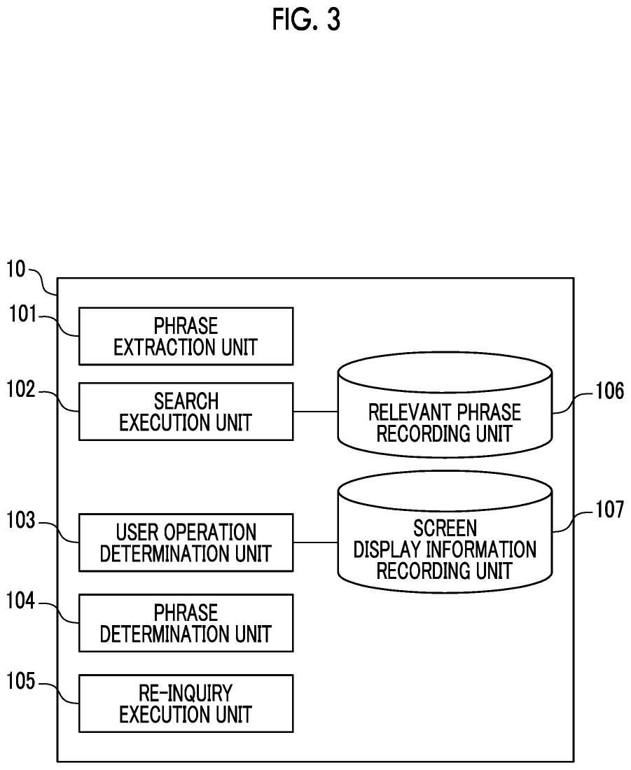

FIG. 3 is a block diagram illustrating an example of the functional configuration of the search server 10.

As illustrated in FIG. 3, as the functional configuration, the search server 10 includes a phrase extraction unit 101, a search execution unit 102, a user operation determination unit 103, a phrase determination unit 104, a re-inquiry execution unit 105, a relevant phrase recording unit 106, and a screen display information recording unit 107. Each functional configuration is implemented by causing the CPU 11 to read and execute the search program stored in the ROM 12 or the storage 14.

The phrase extraction unit 101 extracts the phrases to be used for the search from the natural sentence input in the user terminal 20 by the user. For example, a natural sentence “I am operating a company related to construction industry and pays an annual membership fee to an organization in the industry each time. Is the annual membership fee a taxable transaction?” is input in the user terminal 20. The phrase extraction unit 101 extracts phrases “company”, “organization”, “annual membership fee”, “construction industry”, “pays”, “industry”, “operating”, “taxable transaction”, “related to” and “each time” from the natural sentence using a predetermined method. The method of extracting the phrases to be used for the search from the natural sentence input in the user terminal 20 may use any technology such as the technology disclosed in JP2014-096083A.

The search execution unit 102 executes the search of the content using the phrases extracted by the phrase extraction unit 101. In the case of executing the search of the content, the search execution unit 102 uses relevant information between phrases recorded in the relevant phrase recording unit 106. The search execution unit 102 presents the result of the search of the content to the user terminal 20.

The user operation determination unit 103 determines the user operation performed on the result of the search, which is executed by the search execution unit 102, of the content which is presented on the user terminal 20. The user operation determination unit 103 records information in the screen display information recording unit 107 in accordance with the user operation performed on the result of the search of the content. For example, the user operation determination unit 103 records information about the number of displayed entries of the result of the search in the screen display information recording unit 107 in accordance with a scroll operation performed by the user. In addition, for example, the user operation determination unit 103 records an identifier for identifying browsed information in the screen display information recording unit 107 in accordance with an operation of browsing the result of the search by the user.

The phrase determination unit 104 determines the phrase (search phrase) considered meaningful by the user using the result of the search executed by the search execution unit 102 and the information recorded in the screen display information recording unit 107. The information recorded in the screen display information recording unit 107 is updated each time the user operation is determined by the user operation determination unit 103. The phrase determination unit 104 dynamically determines the search phrase each time the information recorded in the screen display information recording unit 107 is updated, that is, each time the user operation is determined by the user operation determination unit 103.

The re-inquiry execution unit 105 presents the search phrase determined by the phrase determination unit 104 to the user terminal 20. The phrase determination unit 104 dynamically determines the search phrase and thus, also dynamically changes the search phrase presented by the re-inquiry execution unit 105. In addition, the re-inquiry execution unit 105 causes the search execution unit 102 to execute the search using the search phrase in accordance with an operation executed on the presented search phrase in the user terminal 20.

By having such a configuration, the search server 10 may dynamically extract the search phrase considered meaningful by the user in accordance with the user operation performed on the result of the search. By dynamically extracting the search phrase considered meaningful by the user, the search server 10 may improve the efficiency of a re-search performed by the user compared to a case where such a search phrase is not dynamically extracted.

Next, an effect of the search server 10 will be described.

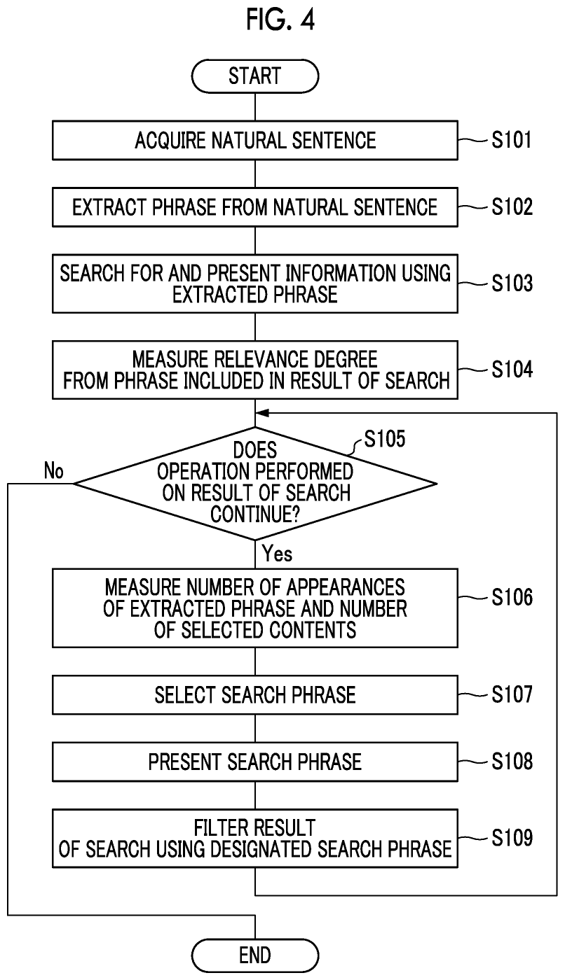

FIG. 4 is a flowchart illustrating a flow of information search process performed by the search server 10. The information search process is performed by causing the CPU 11 to read the search program from the ROM 12 or the storage 14, load the search program into the RAM 13, and execute the search program.

In a case where the user requests the user terminal 20 to search for the content by inputting the natural sentence, the CPU 11 acquires the natural sentence input in the user terminal 20 (step S101). The user may input the natural sentence into the user terminal 20 by operating the keyboard or may input the natural sentence into the user terminal 20 by speaking toward the microphone. In a case where the user speaks toward the microphone, the user terminal 20 converts details of the speaking into a text and then, transmits the converted text to the search server 10.

Next, in step S101, the CPU 11 extracts phrases from the natural sentence transmitted from the user terminal 20 (step S102). As described above, the natural sentence “I am operating a company related to construction industry and pays an annual membership fee to an organization in the industry each time. Is the annual membership fee a taxable transaction?” is input in the user terminal 20. The CPU 11 extracts the phrases “company”, “organization”, “annual membership fee”, “construction industry”, “pays”, “industry”, “operating”, “taxable transaction”, “related to” and “each time” from the natural sentence.

Next, in step S102, the CPU 11 searches for the content using the phrases extracted in step S102 and presents the result of the search to the user terminal 20 (step S103). The content as the target of the search performed by the CPU 11 may be stored inside the search server 10 or may be stored in the apparatus outside the search server 10. For example, the result of the search is presented by a title of the content, a summary of the content, and extraction of a sentence including the phrases in the content. In addition, a predetermined number of entries, for example, 10 entries, are presented at a time in the result of the search.

Next, in step S103, the CPU 11 measures a relevance degree related to a query from the phrases included in each content of the result of the search of each content (step S104).

Next, in step S104, the CPU 11 determines whether or not the user operation performed on the result of the search presented on the user terminal 20 continues (step S105). In a case where the user continues any operation on the result of the search presented on the user terminal 20, there is a possibility that the result of the search presented on the user terminal 20 is not intended by the user.

For example, the user continues repeating an operation of clicking a title displayed as the result of the search with the mouse, displaying the content on the user terminal 20, and then, immediately returning to the result of the search, and further clicking another title. In such a case, there is a possibility that the result of the search presented on the user terminal 20 is not intended by the user. In addition, the user performs an operation of scrolling or switching between pages without clicking a title displayed as the result of the search with the mouse. In such a case, there is also a possibility that the result of the search presented on the user terminal 20 is not intended by the user.

The CPU 11 determines whether or not the result of the search presented on the user terminal 20 is intended by the user by detecting such a user operation.

As a result of the determination in step S105, in a case where the user operation performed on the result of the search presented on the user terminal 20 continues (step S105; Yes), the CPU 11 measures the number of appearances of the extracted phrases in the presented range of the result of the search and the number of contents selected by the user (step S106).

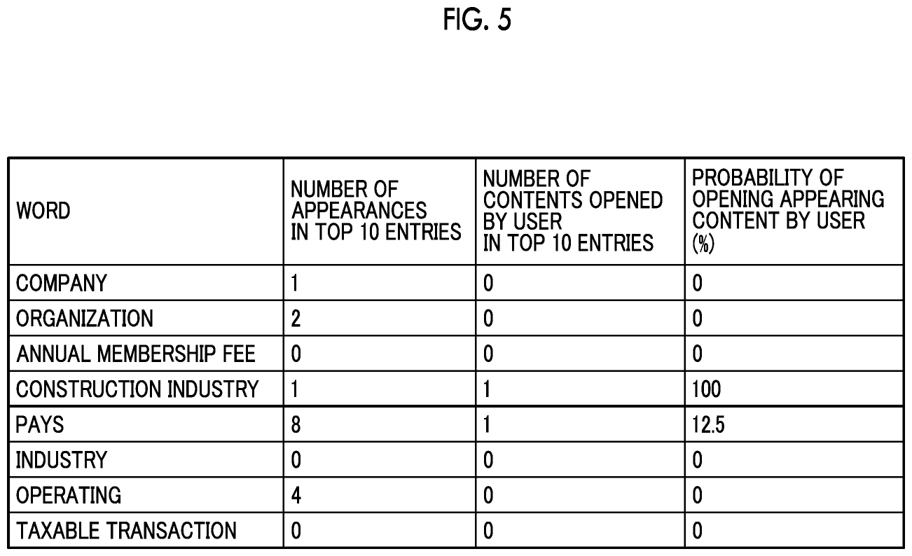

FIG. 5 is a diagram illustrating an example of a measurement result of the number of appearances of each extracted phrase in the result of the search and the number of contents selected by the user. In FIG. 5, the example of the measurement result for each phrase of “company”, “organization”, “annual membership fee”, “construction industry”, “pays”, “industry”, “operating”, and “taxable transaction” is illustrated. In addition, in FIG. 5, the example of the measurement result for each phrase in the top 10 entries of the result of the search is illustrated.

Next, in step S106, the CPU 11 extracts the search phrase that is predicted to be the phrase considered meaningful by the user using the measurement result in step S106 (step S107). In this exemplary embodiment, the CPU 11 extracts the search phrase under the following condition.

The CPU 11 extracts a phrase not appearing in the contents presented at the top as the search phrase which is predicted to be the phrase considered meaningful by the user. In the contents appearing at the top, the CPU 11 may further calculate a priority for each phrase and extract the search phrase based on the calculated priorities. The CPU 11 may calculate the priorities based on a probability of opening the contents appearing at the top by the user. The CPU 11 may extract a phrase for which the calculated probability is high as the search phrase which is predicted to be the phrase considered meaningful by the user.

An example of the search phrase extracted by the CPU 11 will be described with reference to FIG. 5. The CPU 11 extracts a phrase not included in the contents appearing at the top of the result of the search as the search phrase. In other words, the CPU 11 predicts that the phrase considered meaningful by the user is present among phrases included in a content not presented as the result of the search. In the example in FIG. 5, the CPU 11 extracts three phrases “annual membership fee”, “industry”, and “taxable transaction” not appearing even once in the top 10 entries as the search phrase.

In addition, the CPU 11 extracts a phrase for which the probability of opening the contents appearing at the top of the result of the search by the user is greater than or equal to a predetermined threshold, for example, greater than or equal to 50 percent, as the search phrase. In other words, the CPU 11 predicts that a phrase for which the probability of opening by the user is less than the predetermined threshold is a phrase considered not meaningful by the user. In the example in FIG. 5, the CPU 11 extracts “construction industry” for which the probability of opening is 100 percent as the search phrase.

By extracting the search phrase, the CPU 11 predicts that “company”, “organization”, “pays”, and “operating” are phrases considered not meaningful by the user.

The phrase for which the probability of opening the contents appearing at the top of the result of the search by the user is greater than or equal to the predetermined threshold is not necessarily the phrase considered meaningful by the user at all times. For example, as in the example of “construction industry” illustrated in FIG. 5, for a phrase that appears only once, there is a possibility that the user accidentally selects the phrase. Accordingly, the CPU 11 may not extract a phrase of which the number of appearances is one as the search phrase even in a case where the probability of opening by the user for the phrase is greater than or equal to the predetermined threshold.

In addition, the CPU 11 may decide the search phrase to be extracted depending on whether or not the number of appearances of the phrase in the contents at the top of the result of the search is greater than or equal to a threshold. For example, this threshold may be one. In a case where the threshold is set to one, the CPU 11 may extract a phrase not appearing even once in the contents at the top of the result of the search as the search phrase.

A case where multiple search phrases are extracted by the process of step S107 is considered. In a case where search phrases in number greater than or equal to a predetermined threshold, for example, 10, are extracted, the CPU 11 may narrow down the search phrases using another condition.

For example, in a case where search phrases in number greater than or equal to the predetermined threshold are extracted, the CPU 11 may narrow down the search phrases using an inverse document frequency (IDF) value. The IDF value shows a high value in a case where a phrase is not present much in other contents, and shows a low value in a case where a phrase is present in multiple documents. That is, the IDF value shows a high value in the case of a special term that is not used much, and shows a low value in the case of a general term that is widely used. The CPU 11 may narrow down the search phrases to phrases of which the IDF value is greater than or equal to a predetermined threshold.

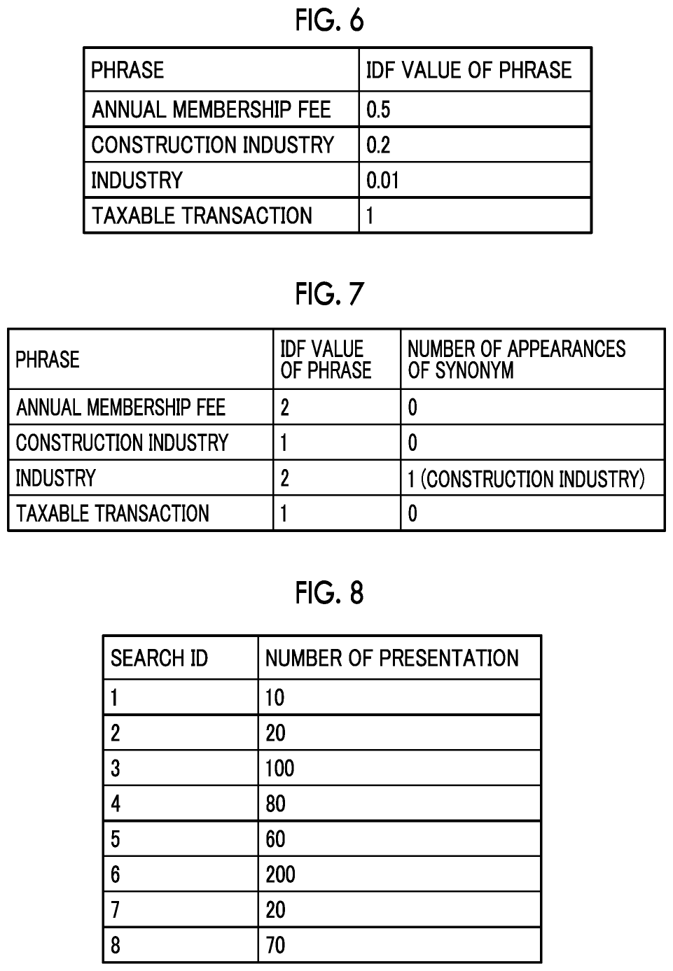

FIG. 6 is a diagram illustrating an example of a relationship between phrases and the IDF value. In FIG. 6, examples of the IDF values of “annual membership fee”, construction industry”, “industry”, and “taxable transaction” are illustrated. The CPU 11 may narrow down the search phrases to phrases of which the IDF value is greater than or equal to 0.5. With reference to FIG. 6, the IDF values of “annual membership fee” and “taxable transaction” are greater than or equal to 0.5. Accordingly, the CPU 11 narrows down the search phrases to “annual membership fee” and “taxable transaction”.

In addition, for example, in a case where search phrases in number greater than or equal to the predetermined threshold are extracted, the CPU 11 may narrow down the search phrases based on the number of appearances of the phrases in the natural sentence input as the query. That is, the CPU 11 may predict that a phrase of which the number of appearances in the natural sentence input as the query is large is the phrase considered meaningful by the user, and may narrow down the search phrases to phrases having a high number of appearances. The number of phrases to which narrowing down is performed is not limited. In addition, in a case where a plurality of phrases having the same number of appearances are present, the CPU 11 may set a phrase for which the number of appearances of a synonym of the phrase is large as the phrase having a high number of appearances.

FIG. 7 is a diagram illustrating an example of a relationship between the extracted search phrase and the number of appearances of each search phrase in the natural sentence. In FIG. 7, the number of appearances of each search phrase in the natural sentence “I am operating a company related to construction industry and pays an annual membership fee to an organization in the industry each time. Is the annual membership fee a taxable transaction?” is illustrated. With reference to FIG. 7, “annual membership fee” appears twice, “construction industry” appears once, “industry” appears twice, and “taxable transaction” appears once. In addition, with reference to FIG. 7, “construction industry” appears once as a synonym of “industry”. The CPU 11 may determine which phrase is a synonym of any phrase using data of a synonym dictionary. The data of the synonym dictionary may be stored in the storage 14 or may be present in the outside apparatus.

The CPU 11 may narrow down the search phrases to “annual membership fee” and “industry” from the result in FIG. 7. In addition, since “annual membership fee” and “industry” have the same number of appearances, the CPU 11 may narrow down the search phrases to only “industry” of which the number of appearances of the synonym is large.

The CPU 11 may dynamically measure the number of appearances in the result of the search and the number of contents selected by the user again in accordance with the user operation performed on the result of the search. For example, in a case where the user scrolls down the result of the search and the result of the search is presented by adding 10 entries on the user terminal 20, the CPU 11 updates the number of presentation of the result of the search by increasing the number by 10. The CPU 11 measures the number of appearances in the result of the search and the number of contents selected by the user again in the updated number of presentation. Accordingly, the CPU 11 may dynamically change the search phrase in accordance with the user operation performed on the result of the search.

FIG. 8 is a diagram illustrating an example of the number of presentation of the result of the search recorded in the screen display information recording unit 107. For each search process, the search server 10 holds the number of presentation of the result of the search in an identifiable format as illustrated in FIG. 8. In this description, the number of presentation is increased to 70 as a result of the user operation performed on the result of the search in the search process having a search ID 8.

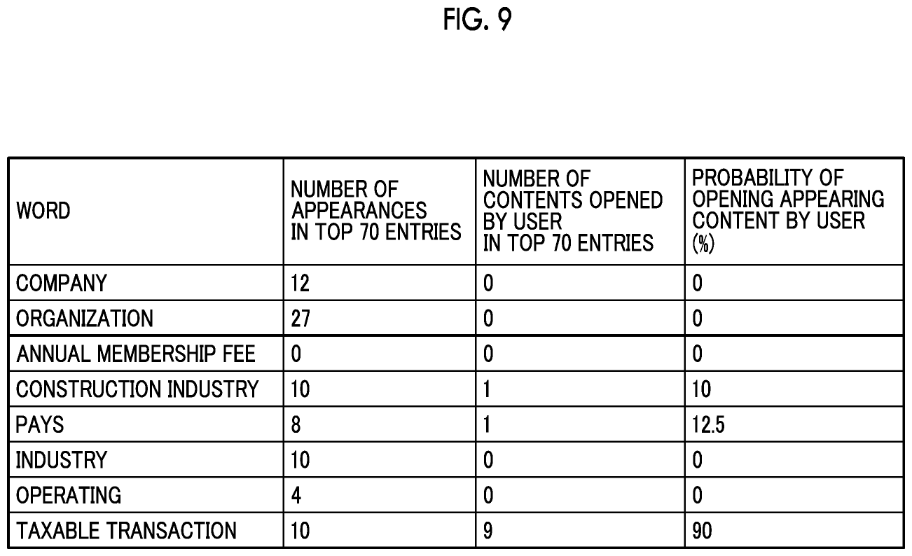

FIG. 9 is a diagram illustrating an example of the measurement result of the number of appearances of each extracted phrase in the result of the search and the number of contents selected by the user. In FIG. 9, the example of the measurement result for each phrase of “company”, “organization”, “annual membership fee”, “construction industry”, “pays”, “industry”, “operating”, and “taxable transaction” is illustrated. In addition, in FIG. 9, the example of the measurement result for each phrase in the top 70 entries of the result of the search is illustrated.

An example of the search phrase extracted by the CPU 11 will be described with reference to FIG. 9. The CPU 11 extracts a phrase not appearing in the contents at the top of the result of the search as the search phrase. In the example in FIG. 9, the CPU 11 extracts “annual membership fee” which is not appearing in the contents at the top of the result of the search as the search phrase.

In addition, the CPU 11 extracts a phrase for which the probability of opening the contents at the top of the result of the search by the user is greater than or equal to a predetermined threshold, for example, 50 percent, as the search phrase. In the example in FIG. 9, the CPU 11 extracts “taxable transaction” for which the probability of opening is 90 percent as the search phrase.

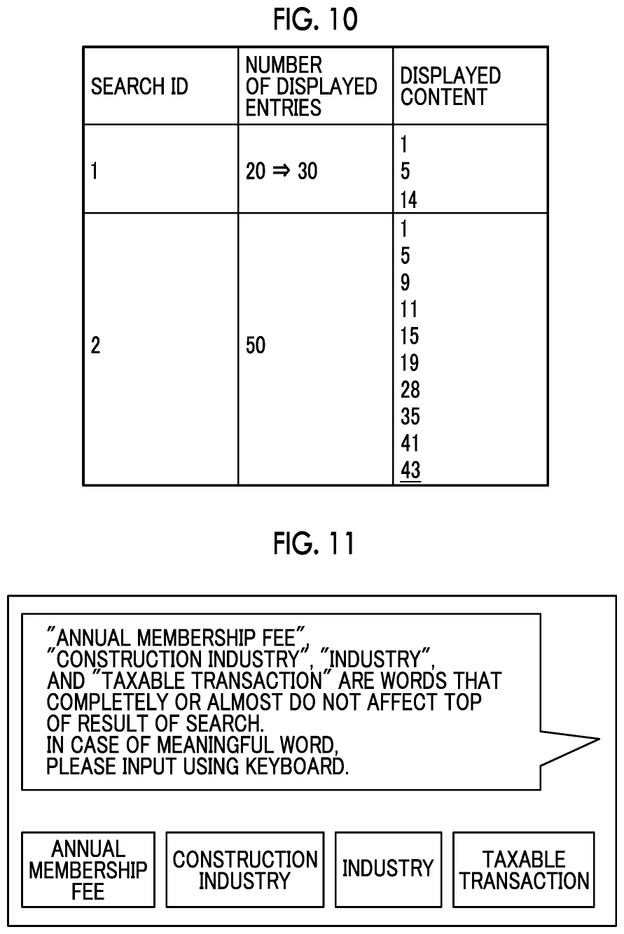

The CPU 11 may dynamically measure the number of appearances in the result of the search and the number of contents selected by the user again in accordance with a change in the number of displayed entries of the contents displayed in the result of the search or a selection operation performed by the user. FIG. 10 is a diagram illustrating an example of the number of displayed entries on the user terminal 20 recorded in the screen display information recording unit 107 and the contents opened by the user for each search process. In FIG. 10, a case where the number of displayed entries on the user terminal 20 is changed to 30 by the user operation for the search process having a search ID 1 is illustrated. In addition, in FIG. 10, a case where a 43rd content is displayed on the user terminal 20 by the user operation for the search process having a search ID 2 is illustrated.

After step S107, the CPU 11 presents the selected search phrase on the user terminal 20 (step S108).

FIG. 11 is a diagram illustrating an example of presentation of the search phrase selected by the CPU 11 on the user terminal 20. In FIG. 11, an example in which the CPU 11 presents “annual membership fee”, “construction industry”, “industry”, and “taxable transaction” on the user terminal 20 as the search phrase is illustrated. The reason that the CPU 11 presents “annual membership fee”, “construction industry”, “industry”, and “taxable transaction” as the search phrase is that such phrases are words that completely or almost do not affect the top of the result of the search. Accordingly, the CPU 11 predicts that these search phrases are phrases considered meaningful by the user.

In a case where the user executes an operation of designating a phrase from the phrases presented as the search phrase on the user terminal 20, the CPU 11 filters the result of the search using the designated phrase (step S109). For example, the user designates “annual membership fee” and “taxable transaction”. The CPU 11 filters the result of the search such that “annual membership fee” and “taxable transaction” are included at the top of the result of the search. For example, the operation of designating the phrase may be input by the user using the keyboard or may be an operation of clicking a presented phrase with the mouse by the user.

In a case where the user executes the operation of designating the phrase from the phrases presented as the search phrase on the user terminal 20, the CPU 11 may change the priority of the designated phrase. In addition, in a case where the user executes the operation of designating the phrase from the phrases presented as the search phrase on the user terminal 20, the CPU 11 may change a weight of contribution of the designated phrase to the result of the search. That is, in a case where the user executes the operation of designating the phrase from the phrases presented as the search phrase on the user terminal 20, the CPU 11 may present the result of the search on the user terminal 20 such that a content including the designated phrase is at the top of the result of the search compared to a content not including the designated phrase.

The CPU 11 continues the series of processes until the user operation performed on the result of the search presented on the user terminal 20 discontinues. In a case where a determination is made that the user operation performed on the result of the search presented on the user terminal 20 discontinues (step S105; No), the CPU 11 finishes the series of processes.

By executing the series of operations, the search server 10 may dynamically extract the search phrase considered meaningful by the user in accordance with the user operation performed on the result of the search. By dynamically extracting the search phrase considered meaningful by the user, the search server 10 may improve the efficiency of a re-search performed by the user compared to a case where such a search phrase is not dynamically extracted.

The information search process executed by causing the CPU to read software (program) in the exemplary embodiment may be executed by various processors other than the CPU. In this case, the processors are illustrated by a programmable logic device (PLD) such as a field-programmable gate array (FPGA) having a circuit configuration changeable after manufacturing, a dedicated electric circuit such as an application specific integrated circuit (ASIC) that is a processor having a circuit configuration dedicatedly designed to execute a specific process, and the like. In addition, the information search process may be executed by one of these various processors or may be executed by a combination of two or more processors of the same type or different types (for example, a plurality of FPGAs and a combination of a CPU and an FPGA). In addition, a hardware structure of these various processors is specifically an electric circuit into which circuit elements such as semiconductor elements are combined.

While an aspect in which the program for the information search process is prestored (installed) in the ROM or the storage is described in the exemplary embodiment, the present invention is not limited to the aspect. The program may be provided in the form of a recording on a recording medium such as a compact disk read only memory (CD-ROM), a digital versatile disk read only memory (DVD-ROM), and a universal serial bus (USB) memory. In addition, the program may be in the form of a download from the outside apparatus through a network.

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to
extract a phrase to be used for a search of information from a natural sentence input by a user,
search for the information using the extracted phrase,
dynamically select a search phrase from the phrase based on the number of appearances of the phrase in the information in a presented range of a result of the search in accordance with an operation related to browsing of the result of the search performed by the user, and
execute a process of presenting the selected search phrase.

2. The information processing apparatus according to claim 1,
wherein the processor is configured to
calculate a priority of each phrase in the information in the presented range of the result of the search, and
dynamically select the search phrase based on the number of appearances and the priority.

3. The information processing apparatus according to claim 2,
wherein the processor is configured to calculate the priority based on the number of browsed information by the user and the number of presentation of the result of the search.

4. The information processing apparatus according to claim 3,
wherein the processor is configured to
calculate a probability of selecting information including each phrase using the number of browsed information by the user and the number of presentation of the result of the search, and
calculate the priority of each phrase based on the probability.

5. The information processing apparatus according to claim 2,
wherein the operation related to browsing of the result of the search is an operation related to selection of the result of the search performed by the user, and
the processor is configured to calculate the priority of each phrase in accordance with the operation related to selection of the result of the search performed by the user.

6. The information processing apparatus according to claim 5,
wherein the processor is configured to dynamically select the search phrase in accordance with the operation related to selection of the result of the search performed by the user.

7. The information processing apparatus according to claim 1,
wherein the operation related to browsing of the result of the search is an operation performed on a display screen of the result of the search by the user, and
the processor is configured to calculate the number of appearances of the phrase in accordance with the operation performed on the display screen of the result of the search by the user.

8. The information processing apparatus according to claim 7,
wherein the operation performed on the display screen of the result of the search by the user is an operation of scrolling the screen.

9. The information processing apparatus according to claim 1,
wherein the processor is configured to change a weight of contribution of the search phrase to the search of the information in accordance with an operation performed on the presented search phrase by the user.

10. The information processing apparatus according to claim 9,
wherein the processor is configured to increase the weight of contribution of the selected search phrase to the search of the information in accordance with an operation related to selection of the presented search phrase.

11. The information processing apparatus according to claim 1,
wherein the processor is configured to select the search phrase based on a frequency of appearances in another result of the search.

12. The information processing apparatus according to claim 2,
wherein the processor is configured to select the search phrase based on a frequency of appearances in another result of the search.

13. The information processing apparatus according to claim 3,
wherein the processor is configured to select the search phrase based on a frequency of appearances in another result of the search.

14. The information processing apparatus according to claim 4,
wherein the processor is configured to select the search phrase based on a frequency of appearances in another result of the search.

15. The information processing apparatus according to claim 5,
wherein the processor is configured to select the search phrase based on a frequency of appearances in another result of the search.

16. The information processing apparatus according to claim 6,
wherein the processor is configured to select the search phrase based on a frequency of appearances in another result of the search.

17. The information processing apparatus according to claim 7,
wherein the processor is configured to select the search phrase based on a frequency of appearances in another result of the search.

18. The information processing apparatus according to claim 8,
wherein the processor is configured to select the search phrase based on a frequency of appearances in another result of the search.

19. The information processing apparatus according to claim 11,
wherein the processor is configured to select a phrase of which the frequency of appearances in the other result of the search is lower than a predetermined threshold as the search phrase.

20. A non-transitory computer readable medium storing a computer program causing a computer to execute a process, the process comprising:
extracting a phrase to be used for a search of information from a natural sentence input by a user;
searching for the information using the extracted phrase;
dynamically selecting a search phrase from the phrase based on the number of appearances of the phrase in the information in a presented range of a result of the search in accordance with an operation related to browsing of the result of the search performed by the user; and
executing a process of presenting the selected search phrase.
